(19) United States
(12) Patent Application Publication
(10) Pub. No.: US 2005/0076048 A1
(43) Pub. Date: Apr. 7, 2005

(54) Plumber glove with integral pipe polisher

(76) Inventor: John Petkovich, Colorado Springs, CO (US)

Correspondence Address: Paul D. Amrozowicz, Esq., 1683 S. Boulder Street, Gilbert, AZ, 85296, US

(21) Appl. No.: 10/447,821

(22) Filed: May 29, 2003

Related U.S. Application Data
(60) Provisional application No. 60/383,924, filed on May 29, 2002.

(51) Int. Cl. G06F 17/00

(52) U.S. Cl. 707/102

(57) ABSTRACT

A metal polishing hand cover includes a sheath and a metal polish material. The sheath is configured to cover at least a portion of a human hand, and has an outer surface and at least one cavity for accepting a human hand therein. The metal polish material is coupled to at least a portion of the sheath outer surface. The hand cover allows a technician, such as a plumber, to perform repair and/or replacement of pipes and polish the pipes without having to remove the glove or carry separate polishing materials.

### CROSS-REFERENCE TO RELATED APPLICATION

This application claims the benefit of U.S. Provisional Application No. 60/383,924, filed May 29, 2002.

### FIELD OF THE INVENTION

The present invention relates to a glove worn by technicians and, more particularly, to a glove worn by a plumber that includes an integral pipe polisher.

### BACKGROUND

Various technicians and craftsman, such as plumbers, that repair and/or replace piping may wear gloves to protect their hands during such repair and/or replacement. In addition, during or after the piping repair and/or replacement, the technician may wish to polish the pipe, or at least some sections of the pipe. In many instances, this polishing operation is accomplished using, for example, a separate piece of polishing material. Thus, technicians may need to set down their tools and, in some cases, also remove the gloves they had on, to obtain the polishing material. Once the polishing material is obtained, the technicians may then place the gloves, if removed, back on the their hands, and then conduct the polishing operation. Thereafter, the polishing material may be set aside, and additional repair may then be effected. This additional repair may be followed by additional polishing operations.

The above-described operational sequence may result in several in the technician conducting several repetitions of reaching for and obtaining the polishing material, polishing portions of the pipe, setting the polishing material aside, effecting one or more additional repairs, obtaining the polishing material, and so on. This operational sequence can be time-consuming and, therefore, inefficient and potentially costly.

Hence, there is a need for a device that overcomes one or more of the drawbacks mentioned above. Namely, a device that allows a technician to repair and/or replace piping sections and polish sections of the repaired and/or replaced piping sections that is less time-consuming, and/or is more efficient, and/or is less costly. The present invention addresses one or more of these drawbacks.

### SUMMARY OF THE INVENTION

In one embodiment, and by way of example only, a metal polishing hand cover includes a sheath and a metal polish material. The sheath is configured to cover at least a portion of a human hand, an has an outer surface and at least one cavity for accepting a human hand therein. The metal polish material is coupled to at least a portion of the sheath outer surface.

### BRIEF DESCRIPTION OF THE DRAWINGS

FIG. 1 is a front view of an exemplary glove according to a particular preferred embodiment of the present invention; and

FIG. 2 is a front view of an exemplary mitten according to an alternative embodiment of the present invention.

### DETAILED DESCRIPTION OF PREFERRED EMBODIMENTS

The following detailed description of the invention is merely exemplary in nature and is not intended to limit the invention or the application and uses of the invention. Furthermore, there is no intention to be bound by any theory presented in the preceding background of the invention or the following detailed description of the invention.

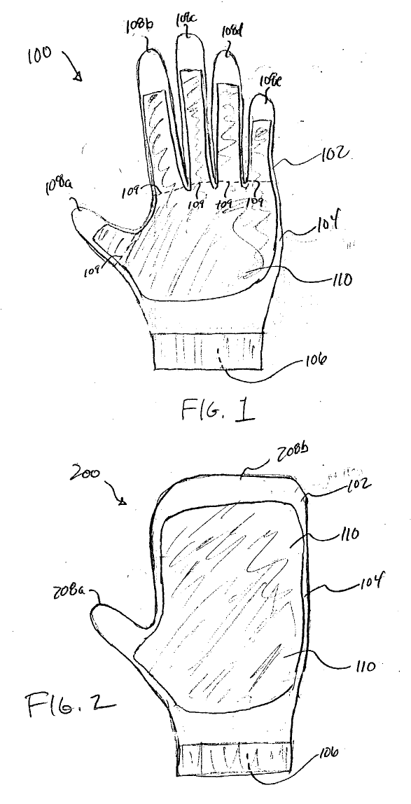

An exemplary glove according to a particular preferred embodiment is shown in FIG. 1. The glove 100 includes a sheath 102 that is configured to cover a human hand (not shown). The sheath 102 includes an outer surface 104 and an inner surface that forms a cavity 106. The cavity 106 is dimensioned to allow a human hand to be placed therein. In the embodiment depicted in FIG. 1, the outer surface 104 and cavity 106 additionally include five separate finger compartments 108a-e, into which at least one finger may be inserted.

The finger compartments 108 are each depicted in FIG. 1 as being fully enclosed so that each finger, when inserted within a finger compartment 108, is completely surrounded by the compartment 108. It will be appreciated that this is merely exemplary of a particular preferred embodiment, and that the finger compartments 108 could also be configured to only partially enclose one or more of the fingers inserted therein. It will additionally be appreciated that instead of finger compartments 108, the sheath 102 could instead include one or more openings 109a-e (shown in phantom in FIG. 1) through which the fingers of a human hand may extend. In this alternative embodiment, the entire finger that extends through the opening 109 is uncovered by the sheath 102.

A metal polishing material 110 is coupled to the sheath outer surface 104. In the depicted embodiment, the polishing material 110 is coupled to at least the portion of the sheath 102 that coincides with a wearer's palm, and to a portion of the outer surface of each finger compartment 108. It will be appreciated that this configuration is merely exemplary of a particular preferred embodiment, and that the polishing material 110 could coincide with more or less than these portions of the sheath 102. The polishing material 110 may be coupled to the sheath outer surface 104 in any one of numerous ways. For example, the material 110 could be adhered to the sheath outer surface 104 using any one of numerous known adhesives, the material 110 could be sewn onto the sheath 102 either after, or during, the manufacture of the sheath, or the material 110 could be formed as an integral part of the sheath 102. In a particular preferred embodiment, the material 110 is sewn onto the sheath outer surface 104.

The polishing material 110 may be any one of numerous known materials suitable for polishing metallic pipe. In the preferred embodiment, the polishing material 110 is copper scrub. It will of course be appreciated that this is merely exemplary of a particular preferred embodiment and that various other polishing materials 110 known now, or developed in the future, may be used.

The glove sheath shown in FIG. 1 is formed substantially in the shape of a glove. It will be appreciated that this is merely exemplary of a particular shape, and that other shapes could also be used. For example, as shown in FIG. 2, the sheath 102 may be formed in the shape of a mitten. In this alternative embodiment, the sheath 102 includes only two finger compartments 208a, b. It will be appreciated that the sheath 102 could also be configured with less than two, or more than five, finger compartments.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

1. A metal polishing hand cover, comprising:
a sheath configured to cover at least a portion of a human hand, the sheath having an outer surface and at least one cavity for accepting a human hand therein; and
a metal polish material coupled to at least a portion of the sheath outer surface.

2. The cover of claim 1, wherein the metal polishing material covers at least that portion of the sheath that corresponds to a palm of a human hand when the hand is inserted in the cavity.

3. The cover of claim 1, wherein the sheath is configured substantially in a form of a glove.

4. The cover of claim 1, wherein the sheath is configured substantially in a form of a mitten.

5. The cover of claim 1, further comprising:
one or more finger compartments extending from the sheath, each finger compartment configured to receive one or more fingers therein.

6. The cover of claim 5, wherein each finger compartment is configured to completely surrounds each finger inserted therein.

7. The cover of claim 5, wherein each finger compartment is configured to only partially surround each finger inserted therein.

8. The cover of claim 1, further comprising:
a plurality of openings formed in the sheath, each opening configured to receive one or more fingers therein.

9. A metal polishing hand cover, comprising:
a sheath configured to cover at least a portion of a human hand, the sheath having an outer surface and at least one cavity for accepting a human hand therein;
a metal polish material coupled to at least a portion of the sheath outer surface; and
one or more finger compartments extending from the sheath, each finger compartment configured to receive one or more fingers therein.

10. The cover of claim 9, wherein the metal polishing material covers at least that portion of the sheath that corresponds to a palm of a human hand when the hand is inserted in the cavity.

11. The cover of claim 9, wherein the sheath is configured substantially in a form of a glove.

12. The cover of claim 9, wherein the sheath is configured substantially in a form of a mitten.

13. The cover of claim 9, wherein each finger compartment is configured to completely surrounds each finger inserted therein.

14. The cover of claim 9, wherein each finger compartment is configured to only partially surround each finger inserted therein.

15. The cover of claim 1, further comprising:
an opening formed in a portion of each finger compartment.
